(19) United States
(12) Patent Application Publication
(10) Pub. No.: US 2004/0250542 A1
(43) Pub. Date: Dec. 16, 2004

(54) Gas generator

(75) Inventor: Takuma Nishina, Hikone-shi (JP)

Correspondence Address: FOLEY AND LARDNER, SUITE 500, 3000 K STREET NW, WASHINGTON, DC, 20007, US

(73) Assignee: TAKATA CORPORATION

(21) Appl. No.: 10/650,976

(22) Filed: Aug. 29, 2003

(30) Foreign Application Priority Data
Jun. 13, 2003 (JP) 2003-169592

(51) Int. Cl. F02N 13/00

(52) U.S. Cl. 60/632

(57) ABSTRACT

A gas generator includes an initiator having a cup filled with a reactive agent, a header for closing the cup, and electrode pins. A resin mold is formed to surround the header and the base of the electrode pins. The part of the mold remote from the header forms a plug-in section of elliptical cross section. A substantially ring-shaped holder has an initiator-holding hole of elliptical cross section on its inner periphery. The plug-in section is inserted in the holding hole to be held therein. The ratio S₁/S₂ between the opening area S₁ of the holding hole and the cross-sectional area S₂ of the header is 0.5 or less. The gas generator is capable of reliably preventing a header from coming off during the operation of the gas generator.

### BACKGROUND

The present invention relates to an initiator suitable for incorporation into a gas generator of an airbag system, a pretensioner, and the like. The present invention also relates to a gas generator that includes the initiator.

Airbag systems mounted to high-speed mobile units, such as cars, are constructed to rapidly inflate a bag-shaped airbag by a gas generator called an inflator. The gas generators include a gas generating agent and an initiator for starting the gas generating reaction of the gas generating agent. The initiator generally includes a reactive agent and a filament-like bridge wire serving as a heating resistor for starting the reaction of the reactive agent.

Referring to FIG. 3, an example of a gas generator will be described. Japanese Unexamined Patent Application Publication No. 2000-292100 describes a similar structure. FIG. 3(a) is a sectional view of the gas generator, along the direction in which an initiator is inserted; FIG. 3(b) is a sectional view of the gas generator of FIG. 3(a), taken along line B-B; FIG. 3(c) is a sectional view of the gas generator of FIG. 3(d), taken along line C-C; and FIG. 3(d) is an explanatory view of the engagement between the initiator and a holder.

An initiator 10 has a cup 12 substantially shaped like a cylinder with a bottom whose rear part is open. The cup 12 houses a reactive agent 14. The rear of the cup 12 is closed by a header 16. The end of an electrode pin 18 passes through the header 16. The cup 12, the reactive agent 14, and the header 16 constitute an ignition reactor section.

A bridge wire 22 is placed between the end of the electrode pin 18 and the header 16. Opposite ends of the bridge wire 22 are welded to the electrode pin 18 and the header 16, respectively. The bridge wire 22 is in contact with the reactive agent 14 in the cup 12.

The electrode pin 18 and the header 16 are arranged apart from each other via an insulting material 26, such as glass and the like, so as not to come in electrical contact with each other.

An electrode pin (ground pin) 20 projects from the header 16. A resin mold 24 is formed to surround the header 16 and the base of the electrode pins 18 and 20. The part of resin mold 24 adjacent to the header 16 forms a major-diameter section 24a and the part remote from the header 16 forms a minor-diameter plug-in section 24b.

The initiator 10 in inserted in a substantially ring-shaped initiator holder 30 and held therein. The holder 30 has an inward-flanged retaining step 32 on its inner periphery. The inner periphery of the retaining step 32 serves as an initiator-holding hole 34. The plug-in section 24b of the resin mold 24 of the initiator 10 is inserted in the initiator-holding hole 34 and the major-diameter section 24a is retained by the retaining step 32.

The holder 30 includes a first cylinder 36 and a second cylinder 38 arranged coaxially. The resin mold 24 of the initiator 10 is fitted in the first cylinder 36 on its inner periphery and the end of the first cylinder 36 is bent inward, so that the initiator 10 is fixed to the holder 30 to be integrated with each other. A casing 40 is fitted on the first cylinder 36. The casing 40 is shaped like a cylinder with a bottom, one end of which is closed and the other end of which is open. The open end of the casing 40 is fitted on the first cylinder 36 and is inserted between the first cylinder 36 and a second cylinder 38.

The rim of the open end of the casing 40 forms a flange 40a that expands outward. After the flange 40a has been inserted between the first cylinder 36 and the second cylinder 38, the end of the second cylinder 38 is bent inward, so that the casing 40 and the holder 30 are fixed together. Prior to being fixed to the holder 30, the casing 40 is filled with a gas generating agent 42.

In known gas generators, the header 16 of the initiator 10 and the initiator-holding hole 34 have the same diameter. Specifically, the ratio S₁/S₂ between the opening area S₁ of the initiator-holding hole 34 and the cross-sectional area S₂ of the header 16 perpendicular to the direction in which it is inserted into the initiator-holding hole 34 is approximately 1.

In a gas generator having such an arrangement, voltage is applied to the bridge wire 22 from a battery through the electrode pins 18 and 20 in the event of an emergency, such as a car crash. Thus, the bridge wire 22 generates heat to ignite the reactive agent 14, thereby starting reaction. The reaction of the reactive agent 14 generates high-pressure gas and heat, and the gas generating agent 42 of the gas generator causes a gas generating reaction. The cup 12 is broken with the reaction to emit a hot gas and so on.

A first reactive agent and a second reactive agent are used as the reactive agent 14. The first reactive agent is arranged to surround the bridge wire 22 and is composed of lead styphnate and aluminum powder. The second reactive agent is arranged to surround the first reactive agent and is composed of BKNO₃ or black powder. The first reactive agent causes a rapid exothermic reaction, and the second reactive agent starts reaction by the heat of the first reactive agent to generate a high-pressure hot gas and impalpable particles.

The gas generating agent 42 starts a gas generating reaction by the operation of the initiator 10 to break the casing 40, thereby emitting a large amount of gas.

A gas generator having such an arrangement generally applies a high gas pressure to the initiator 10 rightward of FIG. 3 when emitting gas. With such gas generators, the header 16 of the initiator 10 has substantially the same diameter as that of the initiator-holding hole 34, as shown in FIG. 3. Due to the extremely high gas pressure applied to the initiator 10 rightward of FIG. 3, the resin mold 24 needs to have high strength in order to prevent the header 16 of the initiator 10 from coming off the initiator-holding hole 34 and breaking the resin mold 24.

### SUMMARY OF THE INVENTION

It is an object of the present invention to provide a gas generator reliably capable of preventing a header from coming off during operation of the gas generator, without taking measures to increase the strength of the resin mold.

A gas generator according to an embodiment of the invention includes an initiator having an ignition reactor section; a holder for holding the initiator; a gas generating agent arranged outside the ignition reactor section of the initiator; and an outer shell surrounding the gas generating agent and secured to the holder. The holder has an initiator-holding hole in which the initiator is inserted and held therein. The ratio S₁/S₂ between the opening area S₁ of the initiator-holding hole and the cross-sectional area S₂ of the ignition reactor section perpendicular to the direction in which the initiator is inserted is 0.5 or less. The ratio S₁/S₂ can be from 0.2 to 0.5.

In the gas generator according to this embodiment of the invention, since the ratio S₁/S₂ between the opening area S₁ of the initiator-holding hole and the cross-sectional area S₂ of the ignition reactor section perpendicular to the direction in which the initiator is inserted is as small as 0.5 or less, the ignition reactor section of the initiator is reliably prevented from coming off during the operation of the gas generator.

According to an embodiment of the invention, the initiator includes a disk-shaped header, a current-carrying pin extending from one surface of the header, a casing surrounding the other surface of the header, a reactive agent filling between the header and the casing, and a bridge wire energized through the pin to start the reaction of the reactive agent, wherein the cross-sectional area S₂ is the cross-sectional area of the header.

In a gas generator with such an arrangement, since the header of the initiator is securely held in the initiator-holding hole, the initiator can be securely held even when gas pressure applied to the initiator is high during the operation of the gas generator.

When the cross section of the ignition reactor section of the initiator and the cross section of the initiator-holding hole are made different, the initiator is reliably prevented from coming off during operation of the gas generator. For example, the cross section of the ignition reactor section perpendicular to the direction in which the initiator is inserted may be circular, and the cross section of the initiator-holding hole perpendicular to the direction in which the initiator is inserted may be noncircular.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1(a) is a sectional view of a gas generator according to an embodiment of the present invention, along a direction perpendicular to the direction in which an initiator is inserted into a holder.

FIG. 1(b) is a sectional view of the gas generator of FIG. 1(a), prior to engagement of the initiator with the holder.

FIG. 2(a) is a sectional view of a gas generator according to another embodiment of the present invention, along a direction perpendicular to the direction in which the initiator is inserted into the holder.

FIG. 2(b) is a sectional view of the gas generator of FIG. 2(a), prior to engagement of the initiator with the holder.

FIG. 3(a) is a sectional view of a known gas generator, along the direction in which an initiator is inserted into a holder.

FIG. 3(b) is a sectional view of the gas generator of FIG. 3(a), taken along line B-B.

3(c) is a sectional view of the gas generator of FIG. 3(d), taken along line C-C.

FIG. 3(d) is an explanatory view of the engagement between the initiator and a holder.

### DETAILED DESCRIPTION

Embodiments of the present invention will be described below with reference to the drawings.

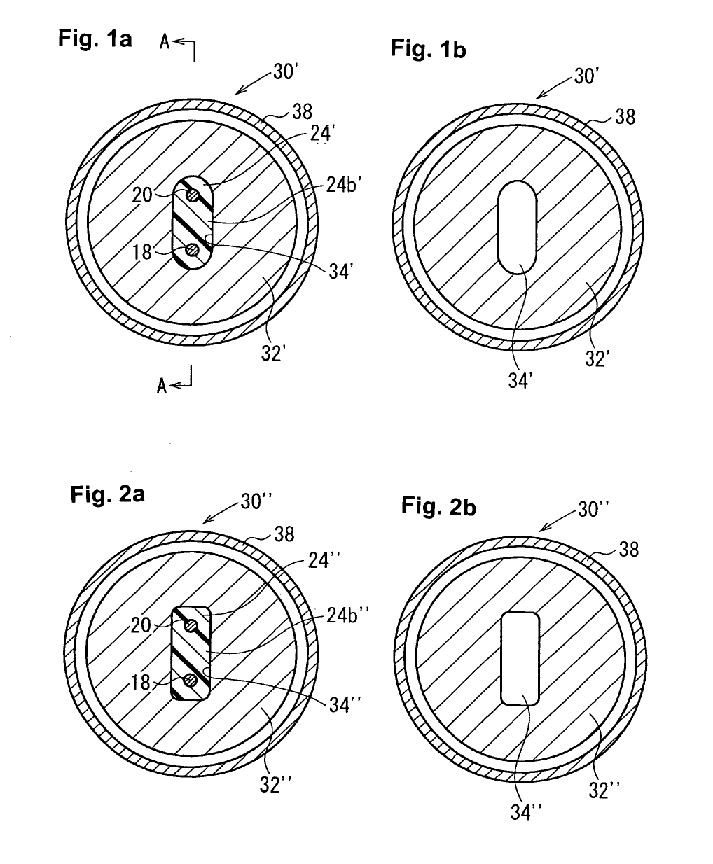

FIG. 1(a) is a sectional view of a gas generator according to an embodiment of the present invention, along a direction perpendicular to the direction in which an initiator is inserted into a holder; and FIG. 1(b) is a sectional view of the gas generator of FIG. 1(a), prior to engagement of the initiator with the holder.

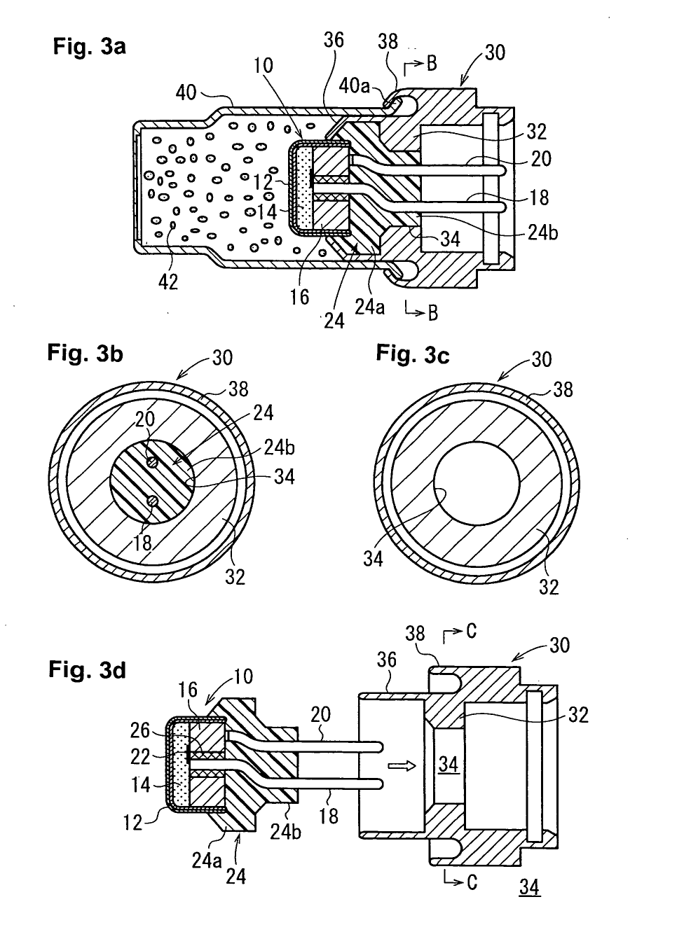

The sectional view of the initiator according to the embodiment of the invention, taken along the length or along line A-A of FIG. 1, is precisely the same as that of FIG. 3. Therefore, the illustration will be omitted here. In this embodiment, an initiator-holding hole 34′, provided in a retaining step 32′ of a holder 30′ for holding the initiator, and an initiator plug-in section 24′, configured to be inserted into the initiator-holding hole 34′, are different in shape from those of conventional gas generators.

Specifically, the holder 30′ according to the illustrated embodiment has an initiator-holding hole 34′ with an elliptical cross section at the center of the retaining step 32′. The ratio S₁/S₂ between the opening area S₁ of the initiator-holding hole 34′ and the cross-sectional area S₂ of the header 16 (refer to FIG. 3) is 0.5 or less, and, in some embodiments, from 0.2 to 0.5.

The part of a resin mold 24′ remote from the header 16 serves as a plug-in section 24b′ of elliptical cross section. The plug-in section 24b′ is inserted in the initiator-holding hole 34′ of the holder 30′ and held therein.

Since the other structures of the gas generator according to the embodiment of FIGS. 1a-1b are the same as those of the gas generator of FIG. 3, the same reference numerals indicate the same component.

In a gas generator with such an arrangement, voltage is applied to the bridge wire 22 (refer to FIG. 3) from a battery through the electrode pins 18 and 20 in the event of an emergency, such as a car crash. The bridge wire 22 generates heat to ignite the reactive agent 14 in the cup 12 (refer to FIG. 3), thereby starting a reaction. The reaction of the reactive agent 14 generates high-pressure gas and heat; thus, a gas generating agent of the gas generator causes a gas generating reaction. The cup 12 is broken with the reaction to emit a hot gas and so on. The ratio S₁/S₂ between the opening area S₁ of the initiator-holding hole 34′ and the cross-sectional area S₂ of the header 16 is as small as 0.5 or less, and can be from 0.2 to 0.5. Therefore, even when the header 16 is put under high pressure on the order of 170 MPa to 200 MPa during operation of the gas generator (which is sufficient pressure to cause the header 16 to come off from an initiator-holding hole in known gas generators and to break the resin mold 24) the header 16 cannot come off the initiator-holding hole 34′ of the embodiment of FIGS. 1a-1b because the opening area S₁ of the initiator-holding hole 34′ is sufficiently smaller than the cross-sectional area S₂ of the header 16, so that the header 16 is held by the holder 30′. This arrangement reliably prevents the header 16 from coming off from the initiator-holding hole 34′.

In this embodiment, the header 16 is circular in cross section, and the opening of the initiator-holding hole 34′ is elliptic in cross section. Thus, the header 16 and the initiator-holding hole 34′ have different shapes. This prevents the header 16 from coming off from the initiator-holding hole 34′ more reliably.

According to the embodiment of FIGS. 1a-1b, although the cross section of the initiator-holding hole 34′ and the cross section of the plug-in section 24b′ of the resin mold 24′ are elliptic, these structures can have other shapes as long as they are not circular. For example, the cross sections of the initiator-holding hole 34′ and the plug-in section 24b′ can be quadrangular, polygonal, or cross shaped or the like. For example, as shown in FIG. 2, the cross section of the initiator-holding hole 34″ formed in retaining step 32″ can be generally rectangular, and, likewise, the cross section of a plug-in section 24b″ of a resin mold 24″ to be inserted in the initiator-holding hole 34″ can be generally rectangular.

In addition, since the ratio S₁/S₂ between the opening area S₁ of the initiator-holding hole 34″ and the cross-sectional area S₂ of the header 16 is as small as 0.5 or less, and can be from 0.2 to 0.5, and since the cross sections of the initiator-holding hole 34″ and the plug-in section 24b″ are different from that of the header 16, the header 16 is reliably prevented from coming off. Furthermore, since the initiator-holding hole 34″ is rectangular, it can be formed by press working, thus reducing the cost of producing the holder 30.

As described above, the present invention provides a gas generator capable of reliably preventing a header from coming off during operation of the gas generator, without taking measures to increase the strength of a resin mold of an initiator.

The priority application, Japanese Patent Application No. 2003-169592 filed Jun. 13, 2003, is hereby incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A gas generator, comprising
an initiator having an ignition reactor section;
a holder for holding the initiator;
a gas-generating agent arranged outside the ignition reactor section of the initiator; and
an outer shell surrounding the gas-generating agent and secured to the holder, the holder having an initiator-holding hole in which the initiator is inserted and held therein,
wherein the ratio S₁/S₂ between the opening area S₁ of the initiator-holding hole and the cross-sectional area S₂ of the ignition reactor section perpendicular to the direction in which the initiator is inserted is 0.5 or less.

2. A gas generator according to claim 1, wherein the ratio S₁/S₂ is from 0.2 to 0.5.

3. A gas generator according to claim 1, wherein the initiator comprises a disk-shaped header, a current-carrying pin extending from one surface of the header, a casing surrounding the other surface of the header, a reactive agent filling between the header and the casing, and a bridge wire energized through the pin to start the reaction of the reactive agent,
wherein the cross-sectional area S₂ is the cross-sectional area of the header.

4. A gas generator according to claim 1, wherein the cross section of the ignition reactor section perpendicular to the direction in which the initiator is inserted and the cross section of the initiator-holding hole perpendicular to the direction in which the initiator is inserted are different from each other.
